(19) United States
(12) Patent Application Publication
(10) Pub. No.: US 2012/0001053 A1
(43) Pub. Date: Jan. 5, 2012

(54) ADJUSTMENT DEVICE AND METHOD OF USING

(76) Inventors: Andrew Sirek, Sarona, WI (US); Colton Sirek, Sarona, WI (US)

(21) Appl. No.: 12/706,234

(22) Filed: Feb. 16, 2010

(51) Int. Cl. F16M 13/00

(52) U.S. Cl. 248/544

(57) ABSTRACT

The invention includes an adjusting tool that may have a guide member, a support member, a connector and attaching members. The guide member may be a relatively flat piece attachable to a frame. The support member may have a first portion orthogonal with a second portion and the first portion may be attached to an object (or integral with an object) which is to be inserted into the frame. The second portion may have a connector portion for receiving a connector. The connector may also engage a slot or hole of the guide member. The adjusting tool may allow for desired alignment of an object within a frame by transferring rotational movement to linear movement.

### BACKGROUND OF THE INVENTION

1. Field of the Invention

This invention is generally directed to an adjustment device. More particularly, the invention is directed to a device for adjusting objects within a frame.

2. Background Information

Doors and windows have been installed in buildings and structures since the invention of buildings and structures and the like. Sometimes the convention of installing doors or windows or other objects in structures includes guesswork as to where to rigidly set a door or a window or other object with respect to a frame structure.

In a relatively recent development, tools have been used to assist in aligning a door or window or other object within a frame structure. These tools generally require alignment and direct engagement of multiple pieces of the tool to precisely align an object within its frame structure.

### SUMMARY OF THE INVENTION

Although tools exist that may be used in the alignment of a door or window or extension jamb or other object within a frame structure, the inventor has realized improvements thereon. The inventor has realized the existing tools require relatively long manufacturing times due to precise machining operations, long installation times due to particular interactions of the known tools and high raw material costs due to numerous tool parts. The inventor has realized that these detriments of existing window or door or extension jamb alignment tools are unneeded and undesirable in a tool. The inventor has developed a novel tool having low manufacturing times, low raw material costs and low production costs due at least to the use of simple parts that require minimal precision machining. Further, the inventive tool may also have low installation times due at least to simple interactions of the tool parts.

Generally, an embodiment of the invention may include an insert adjuster that comprises a guide member, a support member, a connector and attaching members. The guide member may be a relatively flat piece that may be attached to a structure frame. The support member may have a first portion orthogonal to a second portion and the first portion may be attached to a window or door or extension jamb or other object. The second portion may have a connector portion for receiving and engaging a connector. The connector may also engage a slot or hole of the guide member.

An object of the invention is to provide a tool that may be used to easily align a window or door or other object within a frame structure. Simple or easy alignment may include a tool that requires limited direct interaction between tool parts.

An object of the invention is to provide a tool that may be manufactured using simple material processing methods that are common and, generally, efficient. Such processing may including punching, lathing and other similar processes.

An object of the invention is to provide a tool that may be easily attached to a window or door or jamb extension and the corresponding frame structure. Such easy attachment may be facilitated, at least, because the guide member and support member may not be required to directly engage each other.

A further object of the invention is to provide a tool or tool system that may be at least partially attached to a window or door or other object during the manufacturing of the window or door or other object, and thus, the tool may be distributed with the door or window or other object.

A further object of the invention is to provide a tool that may be distributed as a kit, which has a low cost due to low raw material costs, low manufacturing times and other low cost considerations.

The above summary of the present invention is not intended to describe each illustrated embodiment, aspect, or every implementation of the present invention. The figures and detailed description that follow more particularly exemplify these and other embodiments and further aspects of the invention.

### BRIEF DESCRIPTION OF THE DRAWINGS

The invention may be more completely understood in consideration of the following description of various embodiments of the invention in connection with the accompanying drawings, in which:

FIG. 1 is a perspective view of an embodiment of the invention.

FIG. 2 is a rear view of the embodiment of the invention in FIG. 1.

FIG. 3 is a top plan view of the embodiment of the invention in FIG. 1.

FIG. 4 is a side view of the embodiment of the invention in FIG. 1.

FIG. 5 is a cross-section view taken along line 5-5 in FIG. 4 of an embodiment of the invention.

FIG. 6 is perspective view of a top feature of the embodiment of the invention in FIG. 1.

FIG. 7 is a perspective view of a bottom feature of the embodiment of the invention in FIG. 1.

FIG. 8 is a perspective view of the embodiment of the invention of FIG. 1 in use and in a first position.

FIG. 9 is a perspective view of the embodiment of the invention of FIG. 1 in use and in a second position with respect to FIG. 8.

FIG. 10 is a cross-section view taken along line 10-10 in FIG. 9 of an embodiment of the invention.

While the invention is amenable to various modifications and alternative forms, specifics thereof have been shown by way of example in the drawings and will be described in detail. It should be understood, however, that the intention is not necessarily to limit the invention of the particular embodiments described. On the contrary, the intention is to cover all modifications, equivalents, and alternatives falling within the spirit and scope of the invention and as defined by the appended claims.

### DETAILED DESCRIPTION OF THE INVENTION

The subject inventive adjustment device and methods of using the adjustment device may take on numerous physical and methodical embodiments within the spirit of the invention and only preferred embodiments have been described in detail below, which are not meant to limit the scope or spirit or both of the invention.

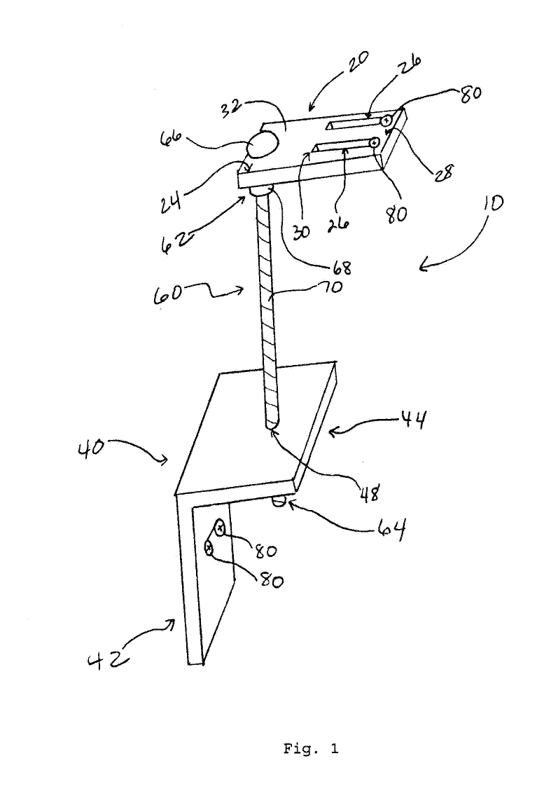

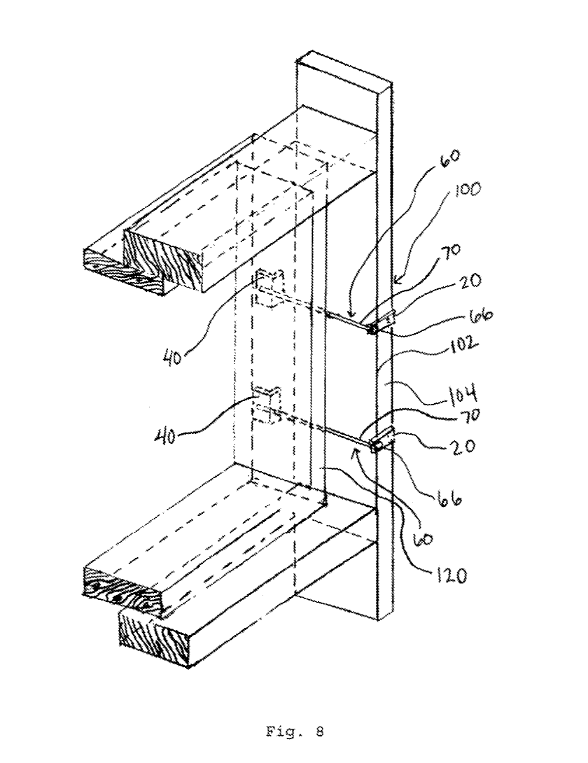

As shown in FIGS. 1-11, adjuster 10 may comprise guide 20, support 40 and connector 60. Guide 20 and support 40 may be independent of one another, which may mean they do not engage or interact except through connector 60. Further, adjuster 10 may also include attaching members 80. Attaching members 80 (of the same or differing sizes) may be utilized for attaching guide 20 to a frame 100 of a building or structure or other object; and for attaching support 40 to an extension jamb 120 of a door or window or other insert. Attaching members 80 may be screws or nails or other known attaching mechanisms. When adjuster 10 is attached to a frame 100 and an extension jamb 120, the device 10 may operate by transferring rotational motion of connector 40 to linear motion of extension jamb 120 with respect to frame 100, or vice versa, allowing for precise adjustment of a window or door with respect to a frame or an object attached to a frame. Further, all parts of adjuster 10 may be made out of the same or different material. Any material may be used to make adjuster 10; for example, plastics, steel, aluminum, etc. may be used to make adjuster 10. Yet further, the parts of adjuster 10 may be formed by simple mechanical processes including, but not limited to lathing, forming, bending, punching and other similar mechanical processes.

A. Guide

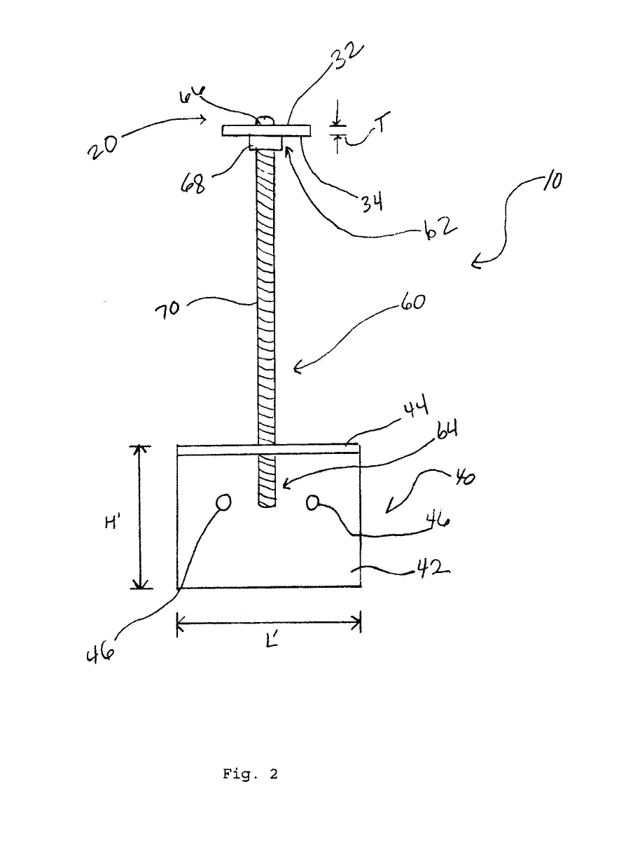

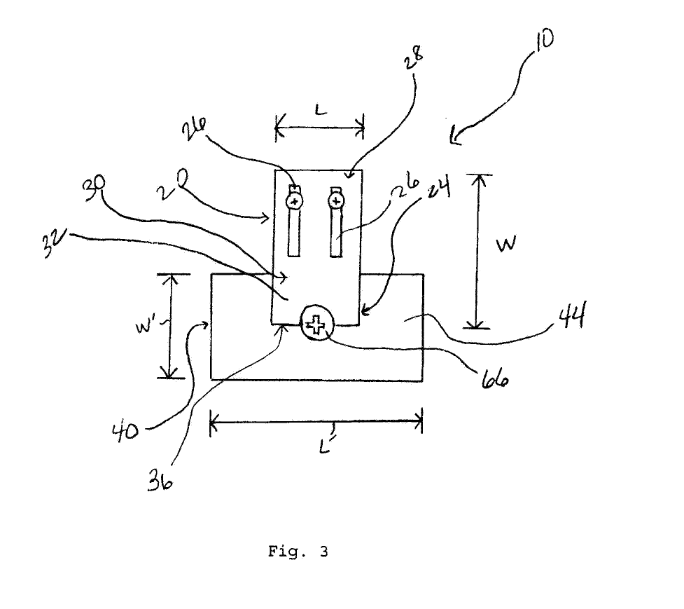

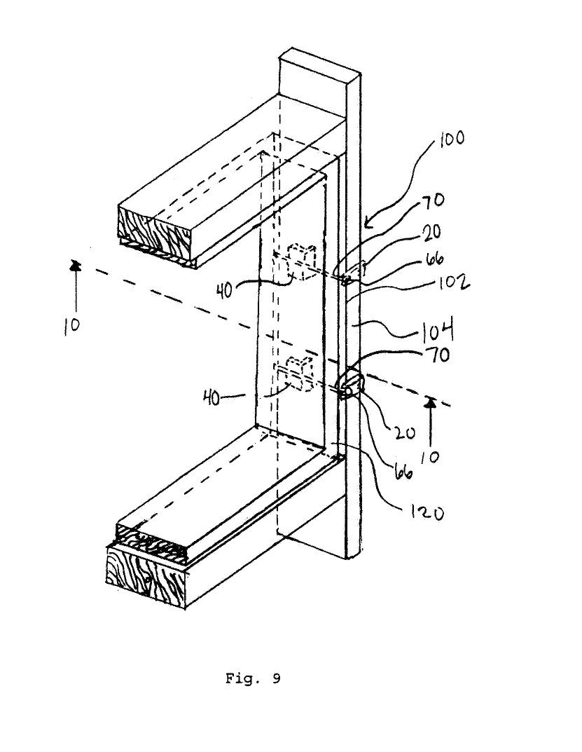

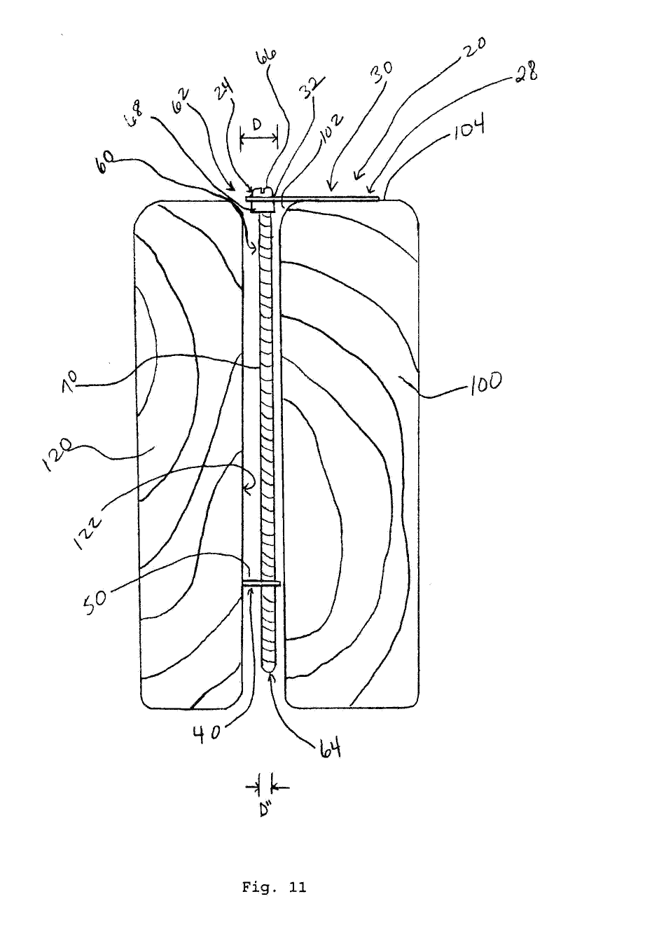

Guide 20 may have any general shape including a rectangular prism shape, a washer shape or other similar shape. For example, as seen in FIGS. 8-10 guide 20 may be a rectangular prism that lies generally flat on a frame 100 (or a jamb 120 or other similar object (not shown)), having a thickness T (FIG. 2), width W and length L (FIG. 3). Guide 20 may be attached to a single (i.e., one and only one) side 104 of frame 100, as shown in FIGS. 8-11. When guide 20 is attached to the side of frame 100, a portion of guide 20 may over-hang an edge 102 of frame 100. Guide 20 may be generally parallel to the side of frame 100, as in FIG. 10.

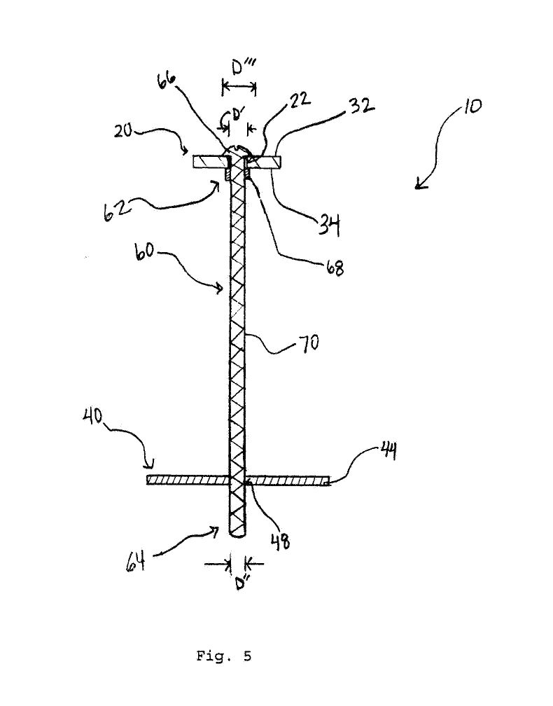

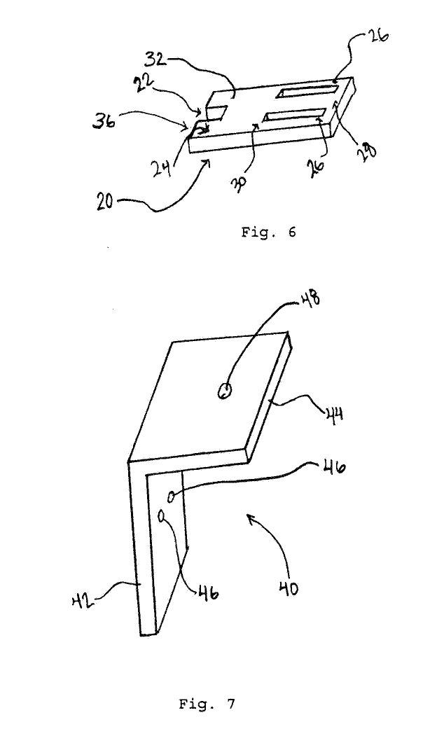

Guide 20 may include guide receiver 22 for receiving a portion of connector 60, such that guide 20 may be oriented perpendicular to connector 60 after connector 60 is received. Guide receiver 22 may take on any shape that is slightly larger than a portion to be received by guide receiver 22 of connector 60. For example, as depicted in FIG. 5, guide receiver 22 has a width or diameter D′ and connector 60 has a diameter D″, where distance D″ is less than distance D′. As seen in FIG. 6, guide receiver 22 may be an open-ended slot or hole or notch or indentation in a first end 24 of guide 20. Typically guide 20 defines guide receiver 22. Regardless of shape or size, an open-ended slot may be considered a slot having an open portion corresponding to edge 36. It may be appreciated that open-ended slot is an indentation that runs through the thickness of guide 20. An open-ended slot of guide receiver 22 allows for simple reception of connector 60 and allows for the easy use of an engaging piece 68 (further discussed in Section C), whether engaging piece 68 is removably connected to connector 60 or is permanently connected to connector 60.

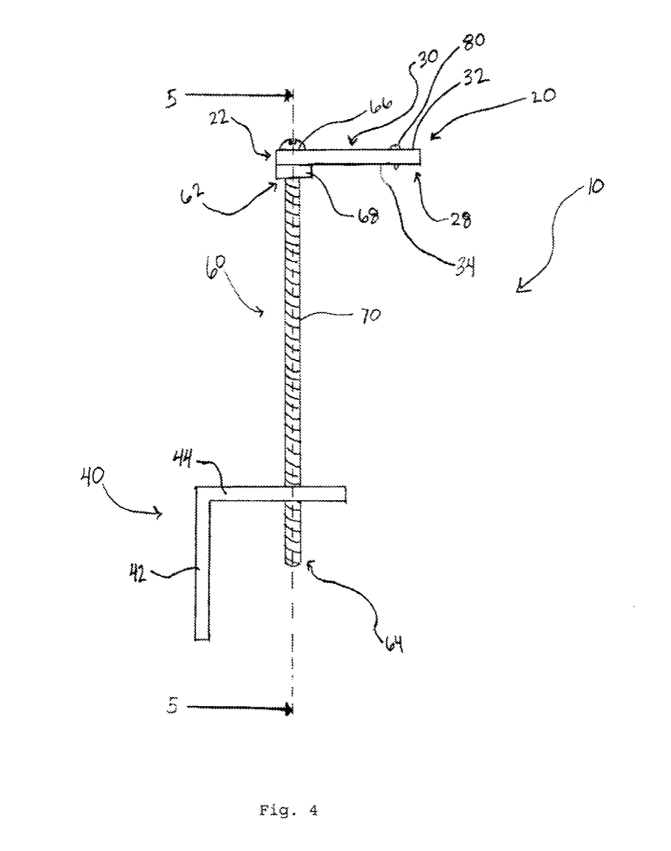

As mentioned above, guide receiver 22 may have any shape and size; for example, as shown in FIG. 5, guide receiver 22 may be slightly larger than connector 60 so as to be able to receive connector 60, yet still provide meaningful guidance of connector 60. Further, guide receiver 22 may take on any three-dimensional shape of a rectangle, triangle, circle, oval and the like, which has an open portion or side along edge 36. Guide receiver 22 may be four-sided; for example and as shown in FIG. 6, guide receiver 22 may have a first side, a second side perpendicular to the first side, a third side perpendicular to the second side and parallel to the first side, and a fourth side, which fourth side may be an open side that corresponds to edge 36, perpendicular to first and third sides and parallel to the second side. It may also be appreciated with reference to FIG. 6, that guide receiver 22 of guide 20 is a notch or open-ended slot. The notch or slot of guide receiver 22 may comprise a variety of shapes configured to receive connector 60 within guide 20 via a translating motion. Because guide receiver 22 may comprise an open slot, connector 60 may be received within guide 20 without having to insert a tip end of connector 60 into guide 20. The open slot arrangement may allow engaging piece 68 (See FIG. 4 and FIG. 5, for instance) to be connected to connector 60. Without an open slot 22, it would be difficult to provide a connector 60 with an engaging piece 68 (unless an engaging piece were inserted after connector was inserted into guide 20). Engaging piece 68 together with rotation piece 66 allows for two-way adjustment of guide 20 upon rotation of connector.

Further, guide 20 may include at least one adjustment path 26. Adjustment path(s) 26 may comprise of a hole through guide 20 and the path(s) 26 may be centered at second end 28 of guide 20. Further, adjustment path 26 may have any shape and may be capable of receiving at least one attaching member 80. For example, as shown in FIGS. 1 and 3, guide 20 may comprise two adjustment paths 26 and an attaching member 80 in each adjustment path 26. Each adjustment path 26 may extend any distance along guide 20. For example, as seen in FIGS. 1, 3 and 6, adjustment paths 26 may extend from a second end 28 of guide 20 to a middle portion 30 of guide 20. Adjustment paths 26 do not necessarily have to be identical in size and shape, but may be the same size and shape. Adjustment path 26 allows for guide 20 to be adjusted with respect to side 104 of frame 100. The width W of guide 20 may be increased (and so may elongated paths 26) to allow a user an additional range of securing options for desired positioning of guide 20. Allowing a greater variety of positions allows a user to accommodate for different sizes of gaps that may exist between a window frame, for instance, and a window jamb. Guide 20 may be adjusted to any position with respect to frame 100, provided that guide receiver 22 (or at least a portion of guide receiver 22) hangs over an edge 102 of frame 100 so as to allow guide receiver 22 to receive connector 60. In one aspect, guide 20 may over hang edge 102 any distance less than or equal to a distance, D (shown in FIGS. 10 and 11), between extension jamb 120 and frame 100.

B. Support

Support 40 may have any general shape; for example, as seen in at least FIGS. 1, 4 and 7-10, support 40 may have a first portion 42 generally orthogonal to a second portion 44. First portion 42 and second portion 44 may be formed from a single piece of material (e.g., through a bending process—see an L-shaped bracket) or each portion 42, 44 may be a separate piece of material rigidly connected. If portions 42, 44 of support 40 are made from separate pieces of material, the portions 42, 44 may be connected by any known connection means that creates a strong connection; for example, a welding means. Generally, first portion 42 may be any shape or size. First portion 42 may be any size; for example, as seen in FIGS. 2 and 10, first portion 42 may be a size (e.g., height H′, length L′) that fits within a perimeter of facing side 122 of extension jamb 120 (or a frame 100 or other similar object).

In one aspect, portion 44 of support 40 may be of a generally planar dimension and may receive connector 60 in a generally perpendicular orientation with respect to portion 44. Guide 20 may also be of a generally planer dimension and receive connector 60 in a generally perpendicular orientation with respect to guide 20.

First portion 42 of support 40 may be attachable to extension jamb 120, or other portion, of a door or window or other insert. First portion 42 may include at least one attaching hole 46 that may be able to receive an attaching member 80. Attaching hole 46 may be elongated to allow for desired adjustment of support 40. Attaching member 80 may be received through attaching hole 26 and inserted into extension jamb 120, for example. Attaching member(s) 80 may work to hold support 40 in place with respect to extension jamb 120.

Second portion 44 may be orthogonal with respect to first portion 42 and second portion may extend toward frame 100 from extension jamb 120. Generally, second portion 44 may be any shape and size; for example, second portion 42 may be any size (e.g., width W′, length L′, as seen in FIG. 3) where length L′ is within the perimeter of facing side 122 and greater than diameter D″, and width W′ is less than or equal to distance D and greater than diameter D″. Further, W′ of second portion 44 may be minimized to allow for the smallest possible distance D between extension jamb 120 and frame 100, as adjusted by adjusting the placement of guide 20 on side 104 of frame 100.

Second portion 44 may include a connector portion 48. Connector portion 48 may be such a shape and size as to be able to receive connector 60. For example, connector 60 may be a round threaded object and connector portion 48 may be a threaded hole defined in second portion 44 to receive connector 60 through rotational motion of connector 60.

Further, in another embodiment, support 40 may comprise of single portion 50, as seen in FIG. 11, integrally connected to extension jamb 122. Single portion 50 may be inserted into, or attached to, a window or door or extension jamb or similar other object. For example, single portion 50 may be inserted into a slot in an extension jamb or other similar object. Single portion 50 may have any shape or size or dimensions; for example, a part of single portion 50 extending from extension jamb 120 may have similar or identical purposes, features and sizes as second portion 44.

In one aspect, single portion 50 may be integrally formed with, or on to, extension jamb 120. Where extension jamb 120 alternatively comprises a metal component of a window, single portion 50 may be a tab formed therein such that single portion 50 may be bent into position from jamb 120 to extend outwardly as generally depicted in FIG. 11. In similar fashion, second portion 42 may actually comprise a component of a window or like product (i.e., be integrally formed thereto) where single portion 50 is a tab that is bent outward from portion 42 in order to fastener 60. The side of a window or other product may contain a series of single portion 50 which may be bent to accommodate receipt of fastener 60. Different sized single portions 50 may be used to accommodate for different sizes of gaps that may exist between jamb 120 and frame 100. Different sized single portions 50 having different sized connector portions 48 to receive connectors 60 having a variety of diameters may also be used. A window or other product may be manufactured with a series of single portions 50 or tabs that can be selectively bent into orthogonal position to accommodate use under a variety of circumstances and with a variety of hardware parts.

C. Connector

Connector 60 may be utilized to connect guide 20 with support 40. Connector 60 may be any shape or size that is able to adjustably connect guide 20 with support 40. For example, connector 60 may comprise an elongated threaded piece 70, as seen in FIGS. 1, 2, 4, 5 and 8-11. At a first end 62 of connector 60, connector 60 may engage guide receiver 22 of guide 20. First end 62 may include a rotation piece 66 and an engaging piece 68. Rotation piece 66 may be any shape and size. For example, as seen in FIG. 5, rotation piece 66 may have a diameter or width D′″, that is greater than a width or diameter D′ of guide receiver 22 so as to not allow rotation piece 66 to pass through guide receiver 22. In one instance rotation piece 66 may include a screw head or a nut head or other aspect allowing for rotation. Engaging piece 68 may be spaced from rotation piece 66 by any distance. For example, engaging piece 68 may be spaced from rotation piece 66 a distance greater than a thickness T of guide 20, as shown in FIG. 2. Both engaging piece 68 and rotation piece 66 are preferably integrally formed as part of connector 60. Engaging piece 68 and/or rotation piece 66 may also be added to an elongated threaded piece 70 of connector 60, or combinations thereof may be integrally formed or later-added. An example of an added engaging piece 68 connected to connector 60 may include a set of nuts such as a double nut stop (i.e., two nuts that abut each other) that threadably engage the elongated threaded piece 70.

Connector 60 may have a second end 64 that may threadably engage support 40 through threaded connector portion 48. When connector 60 is inserted in guide receiver 22 and is threadably engaging connector portion 48, rotational movement of connector 60 causes linear movement of support 40 with respect to guide 20. Further, rotation piece 66 and engaging piece 68 assist in engaging guide 20 by abutting top side 32 and bottom side 34 of guide 20, respectively. Such abutment and engagement of connector 60 with portion 48 allows for two-direction lateral movement of the extension jamb or frame depending on the direction of rotational movement of connector 60.

D. Operation of Adjustment Device

In operation of adjuster 10, support 40 may be attached to extension jamb 120; guide 20 may be attached to frame 100; and connector 60 may slidably (e.g., through horizontal or vertical or both movement) engage guide 20 and threadably engage support 40. Support 40 may be attached to facing side 122 of extension jamb 120 by inserting attaching member(s) 80 through attaching hole(s) 46 and inserting attaching member(s) 80 into facing side 122 or by directly inserting support 40 into facing side 122. Alternatively, single member 50 may be bent into perpendicular position to accommodate insertion of connector 60. Guide 20 may be attached to side 104 of frame 100 by inserting attaching members 80 through adjustment paths 26 and into side 104, at a desired location within adjustment paths 26 and side 104. Prior to tightening attaching members 80, which are to engage guide 20, guide 20 may be desirably aligned with respect to edge 102, support 40 and connector 60. After guide 20 is properly aligned, attaching members 80 may be tightened into side 104. Preferably, guide 20 is positioned such that slot or receiver 22 overhangs edge 102 and preferably receiver 22 aligns with threaded connector portion 48.

After or before, or both, guide 20 is attached to frame 100 and support 40 is attached in a desired allocation to extension jamb 120, support 40 may be aligned with guide 20. Support 40 may be considered to be in alignment with guide 20 when guide 20 is generally parallel to second portion 44 or single portion 50 of support 40 and when guide receiver 22 of guide 20 overlaps with connection portion 48 of support 40. FIG. 5 depicts guide receiver 22 overlapping or aligning with connection portion 48.

After support 40 and guide 20 are attached to an extension jamb 120 and frame 100, respectively, and aligned, connector 60 may then be used to linearly adjust support 40 with respect to guide 20. Connector 60 may be slid into guide receiver 22, where guide receiver 22 engages a portion of the elongated threaded (or unthreaded portion) piece 70 located between rotation piece 66 and engaging piece 68 in an engaged position. When connector 60 is inserted into guide 20, rotation piece 66 may abut a top side 32 of guide 20 and engaging piece 68 may abut a bottom side 34 of guide 20, as shown in FIG. 2.

After sliding connector 60 into guide 20, or before, connector 60 may threadably engage connector portion 48 of support 40. When connector 60 is aligned with connector portion 48, rotation piece 66 of connector 60 may be rotated by a tool or by hand so connector threadably engages connector portion 48. Such rotation, in a first direction, of connector 60 and the engagement with support 40, causes linear movement of support 40 and extension jamb 120 toward guide 20. Rotation of rotation piece 66 and connector 60 in a second direction, opposite the first direction, causes linear movement of support 40 and extension jamb 120 away from guide 20. Such rotational movement transferred to linear movement may allow for precise stable adjustment of windows or doors with respect to the frames to which they are inserted. This operation may allow for convenient in/out adjustments of the windows within a frame and reduces the problem of guesswork and improves speed and accuracy of construction. Thus, a window or a door or other object may be positioned so as to have an interior or exterior side flush with an exterior or interior side of a frame, or the window or door or other object may be set to have a recess of desired depth with respect to an interior or exterior of the frame.

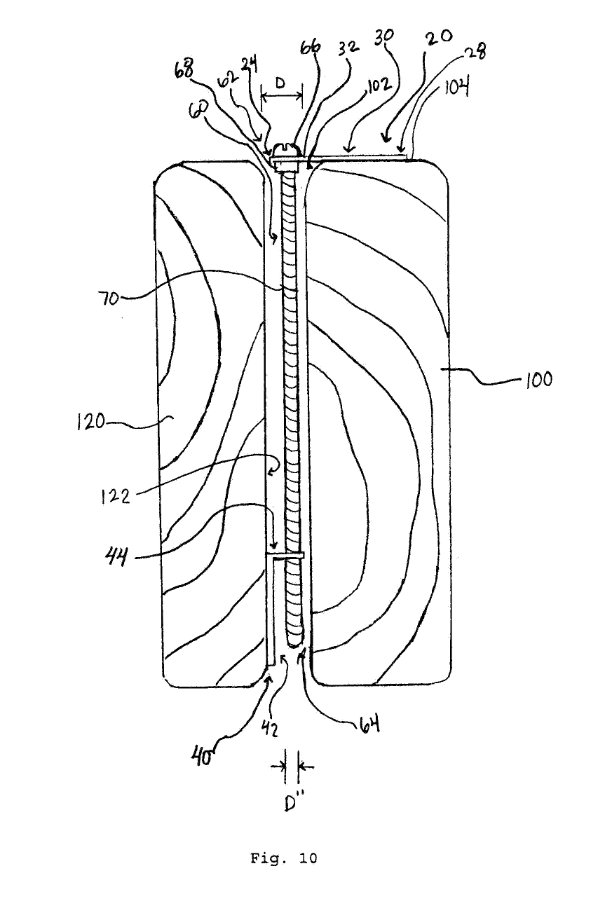

Adjuster 10 may be used by itself or in combination (e.g., FIGS. 8 and 9) with other adjusters 10 to adjust the placement of a window or door or other object(s) with respect to a frame, as described above. In one similar method of use, at least two adjusters 10 may be used to align the window or door with a frame. In an embodiment, when two adjusters are used, a first adjuster 10 may be placed on a first vertical jamb of a window and a second adjuster 10 may be placed on a second vertical jamb of the window. The first vertical jamb may be spaced a distance from the second vertical jamb. Further, the first vertical jamb may be substantially parallel to the second vertical jamb. Of course, any number of adjuster may be used, as desired. The use of multiple adjusters 10 on multiple parallel vertical jambs may allow for each side of a door or window or object to be aligned at the same location with respect to a frame.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise specifically indicated. While the particular ADJUSTMENT DEVICE AND METHOD OF USING as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

What is claimed is:

1. An apparatus, comprising:
a guide having an open-ended slot;
a support having a threaded hole;
an elongated threaded connector having a first end engaging said open-ended slot;
a second end of said elongated threaded connector engaging said threaded hole.

2. The apparatus of claim 1, further comprising:
said elongated threaded connector perpendicularly engaging said guide; and
said elongated threaded connector perpendicularly engaging said support.

3. The apparatus of claim 1, further comprising:
said first end comprising an engaging piece and a rotation piece; and
said engaging piece is spaced a distance from said rotation piece.

4. The apparatus of claim 3, further comprising:
where said first end engages said open-ended slot in an engaged position, and
in said engaged position, said engaging piece abuts a bottom side of said guide and said rotation piece abuts a top side of said guide.

5. The apparatus of claim 4, further comprising:
said engaging piece is integrally formed as part of said elongated threaded connector; and
said rotation piece is integrally formed as part of said elongated threaded connector.

6. The apparatus of claim 1, further comprising:
said guide is oriented substantially perpendicular to a first portion of said support; and
said guide is oriented substantially parallel to a second portion of said support.

7. The apparatus of claim 6, further comprising:
said open-ended slot overlaps said threaded hole such that said connector is positioned substantially perpendicular to said guide when said connector engages said support.

8. The apparatus of claim 7, further comprising:
a frame having multiple sides;
said guide is attached to one and only one frame side; and
said guide overhangs an edge of said frame, and
where the edge is partially formed by said one and only one frame side.

9. The apparatus of claim 1, further comprising:
said support comprises a first portion and a second portion;
said second portion is substantially orthogonal to said first portion.

10. The apparatus of claim 9, further comprising:
said second portion comprises said threaded hole.

11. The apparatus of claim 9, further comprising:
an object to be aligned in a frame;
said object comprises a facing side; and
said first portion is attached to said facing side.

12. The apparatus of claim 11, further comprising:
said guide is substantially parallel to said second portion.

13. The apparatus of claim 12, further comprising:
a frame having a frame side; and
said guide is attached to said frame side.

14. The apparatus of claim 1, further comprising:
said support is integrally connected to an object to be aligned within a frame.

15. An alignment tool for aligning objects within a frame, comprising
a guide;
a support independent from said guide; and
a connector threadably engaged with said support and slidably engaged with said guide, and
where rotational movement of said connector provides linear movement of said support with respect to said guide without direct engagement of said guide with said support.

16. A method of adjustment, comprising:
aligning, in a substantially perpendicular manner, a guide with a first portion of a support while also aligning, in a substantially parallel manner, the guide with a second portion of the support;
engaging a hole in the second portion of the support with a connector; and
engaging the guide with the connector.

17. The method of claim 16, further comprising:
aligning an open-ended slot in the guide with the hole in the second portion of the support.

18. The method of claim 16, further comprising:
where the hole in the second portion is a threaded hole, and
said engaging a hole comprises rotating the connector through the threaded hole.

19. The method of claim 16, further comprising:
said engaging the connector with the guide comprises sliding the connector through an open end of an open-ended slot in the guide.

20. The method of claim 19, further comprising:
where the hole in the second portion is a threaded hole, and
said engaging a hole comprises rotating the connector through the threaded hole;
rotating said the connector in a first direction causing linear movement of the support in a first direction; and
rotating the connector in a second direction causing linear movement of the support in a second direction.

21. The method of claim 16, further comprising:
attaching the first portion to a facing side of an object to be inserted in a frame; and
attaching the guide to one and only one side of the frame, and
where the object is positioned at a first location.

22. The method of claim 21, further comprising:
overhanging a portion of the guide across an edge of the frame, the guide being a relatively flat piece, and
where the edge is partially formed by the one and only one side of the frame.

23. The method of claim 22, further comprising:
rotating the connector to linearly adjust the object to a second location.
